(19) United States
(12) Patent Application Publication
(10) Pub. No.: US 2006/0179079 A1
(43) Pub. Date: Aug. 10, 2006

(54) System, method and apparatus for data transfer between computing hosts

(76) Inventor: Mikko Kolehmainen, Jarvenpaa (FI)

Correspondence Address: Hollingsworth & Funk, LLC;Suite 125, 8009 34th Avenue South, Minneapolis, MN, 55425, US

(21) Appl. No.: 11/054,357

(22) Filed: Feb. 9, 2005

(51) Int. Cl. G06F 17/00

(52) U.S. Cl. 707/104.1

(57) ABSTRACT

A system, method and apparatus to facilitate application and data transfer between a computation host acting as an application source and a computation host acting as an application target. Sufficient execution logic and static data exists between the two computation hosts and a third party interrogation device to allow a determination of the compatibility of applications resident within the source computation host and the application target, as well as the determination of the compatibility between the applications and the interrogation device itself. If compatibility exists, transfer of the applications between the computation hosts via the third party interrogation device is facilitated, whereby the interrogation device supplies temporary storage for the applications.

### FIELD OF THE INVENTION

This invention relates in general to data transfer between computing hosts, and more particularly, to the automatic identification of compatibility prior to the data transfer.

### BACKGROUND OF THE INVENTION

Mobile telecommunications has seen an explosive growth within just the last decade and is expected to continue this growth trend into the future. Whereas mobile communications began in its infancy stages as primarily providing voice only communications, today's mobile communications has by necessity grown in complexity and capacity to accommodate the increasingly demanding requirements of not only voice transfer, but also data transfer in its many forms, such as messaging and browsing.

As the telecommunications industry develops technology to keep pace with the ever increasing demands of its users, a hybridization of the mobile subscriber's interface to the mobile communications network is taking place. The mobile terminal is transforming from a handheld communications device into a data portal used to penetrate the plethora of services and applications that were previously only available to users stationed at land-based, computing terminals having direct connectivity to the Internet. The mobile communications portal is, therefore, taking on many of the land-based computing terminal's characteristics to allow the facilitation of user interactions within the mobile communications environment.

In addition, the mobile terminal itself is transforming into a digital assistant that transcends the role of a land based computing device, by providing mobility functions that are inherently facilitated by the mobile terminal. For example, as mobile terminals are becoming more powerful, they are more capable of synchronizing applications and data with their land based counterparts and are thus becoming an extension, and a complementing element of, the land based computing terminal. As such, mobile terminal users are able to, for example, synchronize their local applications, such as task and contact lists, with the corresponding applications resident within the land based computing terminal, so that the information is made available to the user wherever he or she may be.

In addition, as the Central Processing Unit (CPU) operational speed, memory capacity, and display capabilities of the mobile terminals advance, so does the complexity of applications that are expected to run on those mobile terminals. The capabilities of the mobile terminal and the execution environment that is required by the corresponding application, however, does not always match. As such, it is not known whether the application and its mobile terminal host are compatible, until after the application has been uploaded to the mobile terminal and an attempt at application execution has been performed by the mobile terminal. Thus, compatibility between the mobile terminal and the downloaded application is ascertained only on a trial and error basis.

Similarly, compatibility between an application resident within a source appliance that is intended for a particular target appliance is not known until the application has been transferred form the source appliance to the target appliance and execution is attempted. Such a haphazard approach to application/appliance compatibility, however, is time consuming at the very least, and may even be damaging to the target appliance.

Accordingly, there is a need for a transfer mechanism between a source appliance and a target appliance, which allows for an automated compatibility check to be conducted between the application and the target appliance prior to transfer.

### SUMMARY OF THE INVENTION

To overcome limitations in the prior art, and to overcome other limitations that will become apparent upon reading and understanding the present specification, the present invention discloses a system, method, and apparatus for the determination of the capabilities/requirements of an application available for transfer. The present invention also makes the determination of the capabilities/requirements of an appliance that may be available for receipt of the application.

In accordance with one embodiment of the invention, a method of transferring applications between a computing source and a computing target comprising establishing a connection between the computing source and an interrogation device, transmitting schema associated with the applications from the computing source to the interrogation device, comparing the schema to compatibility criteria to generate a compatibility result, and transmitting the applications from the computing source to the interrogation device in response to the compatibility result.

In accordance with another embodiment of the invention, a system for enabling application transfer between a source appliance and a target appliance comprises a source appliance containing a list of applications and associated attributes to be transmitted in response to creation of a proximity connection, an interrogation device capable of wirelessly coupling to the source appliance via the proximity connection and is adapted to compare the associated attributes to a set of compatibility criteria to generate a first compatibility result. The interrogation device uploads the applications via the proximity connection in response to the first compatibility result. The system further comprises a target appliance capable of wirelessly coupling to the interrogation device and is adapted to receive the uploaded applications from the interrogation device in response to the generation of a second compatibility result.

In accordance with another embodiment of the invention, an application source appliance comprising a means for establishing a proximate connection to an external device, a means for providing attributes associated with applications stored within the application source appliance to the external device via the proximate connection, a means for executing the applications within the application source appliance, and a means for transferring the applications to the external device via the proximate connection in response to a capability match between the attributes associated with the applications and compatibility criteria contained within the external device.

In accordance with another embodiment of the invention, a computer-readable medium having instructions stored thereon which are executable by a source appliance. The instructions perform steps comprising establishing a proximate connection to an external device, providing attributes associated with applications stored within the source appliance to the external device via the proximate connection, executing the applications within the source appliance, and transferring the applications to the external device via the proximate connection in response to a capability match between the attributes associated with the applications and compatibility criteria contained within the external device.

In accordance with another embodiment of the invention, a mobile terminal that is capable of wirelessly coupling to a data transfer system comprises a memory capable of storing at least one of a proximity interface module and an interrogation module and a processor that is coupled to the memory and configured by the proximity interface module to enable transfer of a list of applications contained within a source appliance and attributes associated with the list of applications. The processor is further configured by the interrogation module to compare the attributes to capability criteria, and in response, to generate a list of compatible applications available from the source appliance that match the capability criteria.

In accordance with another embodiment of the invention, a computer-readable medium having instructions stored thereon which are executable by a mobile terminal for effecting data transfer between a source appliance and a target appliance. The instructions perform steps comprising wirelessly obtaining a list of applications and associated attributes contained within the source appliance, comparing the associated attributes to a set of capability criteria to generate a compatibility result for each application, and generating a list containing each application from the source appliance that has an affirmative compatibility result.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates an exemplary proximity network in accordance with the present invention;

FIG. 2 exemplifies various types of schema that may be analyzed by the present invention to determine compatibility;

FIG. 3 illustrates an exemplary interrogation block diagram in accordance with the present invention;

FIG. 4 illustrates an exemplary block diagram of the database agent of FIG. 3;

FIG. 5 illustrates an exemplary User Interface (UI) of a mobile terminal in accordance with the present invention;

FIG. 6 illustrates an exemplary flow diagram of a method in accordance with the present invention;

FIG. 7 illustrates an exemplary Digital Rights Management (DRM) implementation in accordance with the present invention;

FIG. 8 illustrates an exemplary mobile computing arrangement in accordance with the present invention; and

FIG. 9 is a representative computing system capable of carrying out appliance functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, method and apparatus that facilitates application and data transfer between a computation host acting as an application source and a computation host acting as an application target. Sufficient execution logic and static data exists between the two computation hosts and a third party interrogation device, that allows the determination of the compatibility of applications resident within the source computation host and the application target, as well as the compatibility between the applications and the interrogation device itself. If compatibility exists, then the present invention facilitates transfer of the applications between the computation hosts via the third party interrogation device, whereby the interrogation device supplies temporary storage for the applications. In other embodiments of the invention, the interrogation functions and temporary storage operations may exist not only within third party interrogation devices, but within either of the source computation host and/or the application target themselves.

The present invention is applicable in a number of usage scenarios. For example, the present invention supports synchronization of information, data, and applications, i.e., application logic and application execution related state data and metadata, between all relevant devices within a home network. That is to say that the present invention allows tracking of information, data, and applications existent within the appliances that make up the home network by a mobile device entering the respective coverage areas of the home network appliances. Once the mobile device enters the coverage area, and/or proximity area, of the appliances, the appliances may be interrogated by the mobile device to determine whether new information, data, and applications exist on the appliance and whether the new information, data, and applications are compatible with other appliances within the home network or elsewhere. If compatible, the information, data, and/or applications may then be uploaded to the mobile device and temporarily stored there until the mobile device enters the coverage area of the other appliances within the home network. Once the coverage area of the recipient appliance is entered, the compatible information, data, and/or applications may then be automatically uploaded from the mobile device into the recipient appliances without any further user interaction.

In other applications of the present invention, a superdistribution network is contemplated, whereby Digital Rights Management (DRM) systems are used not only to protect digital content from illegal dissemination, but also to define new sets of rules for the content's usage. Such usage rules include usage intent, such as preview, save and modify rights, as well as usage restrictions, such as content validity period, frequency of usage, and location of usage. Other usage rules contemplated by the present invention also include compatibility determinations that are made based upon attribute schema associated with the content and the appliances/mobile devices used to consume the content.

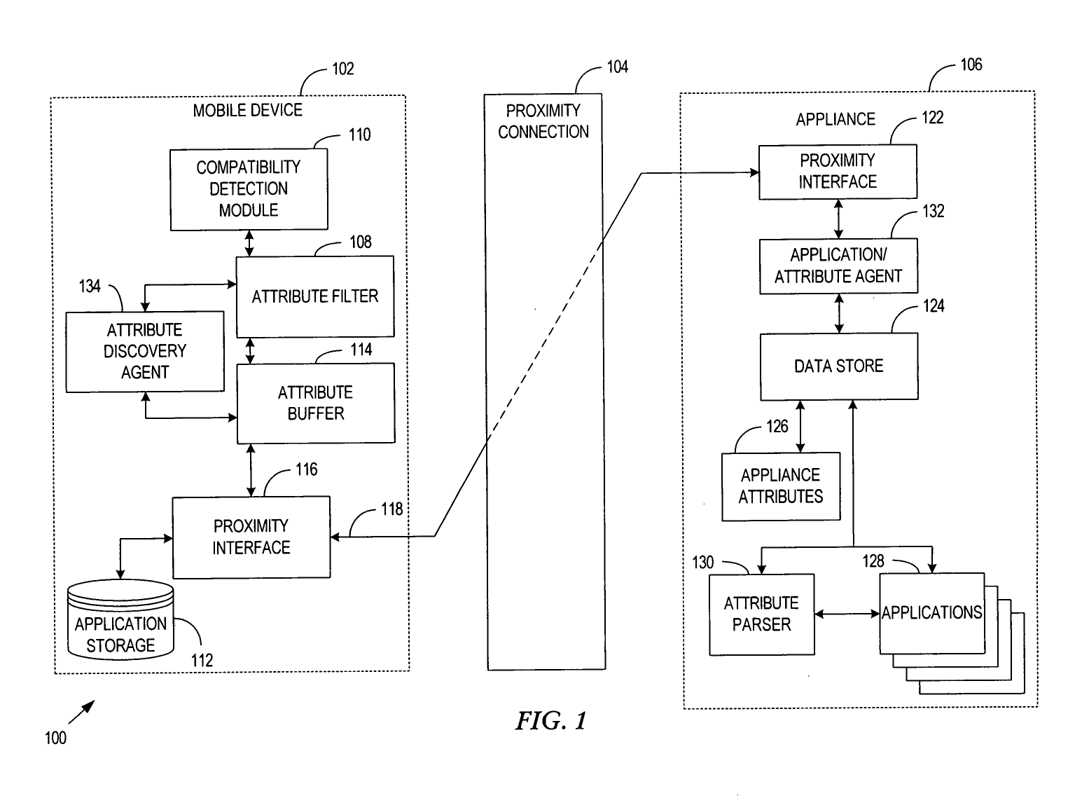

FIG. 1 illustrates a high level block diagram exemplifying a proximity connection that forms a corresponding interrogation link between a mobile device and an appliance in accordance with the present invention. In general, mobile device 102 enters the coverage area of appliance 106 via proximity connection 104, or by coming into physical contact with appliance 106. In one embodiment according to the present invention, proximity connection 104 may include touch-based interaction enabled by Near Field Communication (NFC) technology. NFC has evolved from contactless identification using Radio Frequency Identification (RFID) and related interconnection technologies. NFC operates in the 13.56 MHz frequency range over a distance of typically a few centimeters. NFC is standardized in International Organization for Standardization (ISO) 18092 and is designed to be compatible with other wireless proximity connections such as Bluetooth, InfraRed (IR), Wireless Fidelity (WiFi), etc.

Proximity connection 104 provides a conduit that is used by an automatic interrogation mechanism, e.g., modules 108, 110, 114, and 134, within mobile device 102, whereby new information, data, and applications contained within appliance 106 are discovered. Once the new information, data, and applications available within appliance 106 have been discovered, attributes associated with the newly discovered information, data, and applications may then be uploaded to mobile device 102 via proximity connection interfaces 118 and 122 and stored within attribute buffer 114. Once filtered by attribute filter 108 in accordance with predetermined filtering characteristics, the remaining uploaded attributes may then be analyzed by compatibility detection module 110 to make a compatibility determination of the newly discovered information, data, and applications contained within appliance 106 in accordance with predetermined compatibility criteria. Those newly discovered information, data, and applications that are found to be compatible in accordance with the predetermined compatibility criteria may then be uploaded via proximity connection 104 and temporarily stored within application storage 112.

Various application and application attribute discovery scenarios facilitated by attribute discovery agent 134 are contemplated by the present invention. For example, attribute discovery agent 134 may implement Universal Plug and Play (UPnP) to provide application attribute discovery in accordance with the Simple Service Discovery Protocol (SSDP). SSDP uses the HyperText Transport Protocol (HTTP) over User Datagram Protocol (UDP) and is thus designed for usage in IP networks, where peer to peer mechanisms are enabled for auto configuration of devices, service discovery, and control of services.

The UPnP interface provides mobile device 102 with the ability to query UPnP devices, e.g. devices that include a Content Directory Service (CDS) such as the CDS implemented by application/attribute agent 132 of appliance 106, in order to get attribute information associated with applications 128 to conduct a compatibility determination. Attribute information associated with applications 128 may, for example, be gathered by attribute parser 130 and stored within data store 124 for subsequent access by application/attribute agent 132. Application attributes may include any configuration data that may be required by the application and any supported protocols for connectivity to the application. Application data storage requirements and execution time requirements such as Random Access Memory (RAM) usage, Central Processing Unit (CPU) speed, Operating System (OS), and display characteristics may also be associated with the applications and are thus pertinent to the compatibility determination.

Appliance attributes 126 may also be ascertained from data store 124, which is a storage container that is provided by appliance 106 to store hardware dependent attributes of target appliances required to execute applications 128. That is to say, for example, that a portion of the compatibility criteria analyzed by compatibility detection module 110 and attribute filter 108, in conjunction with attribute discovery agent 134, of mobile device 102 includes any hardware limitations that may be associated with potential target appliances that are candidates for execution of applications 128. Should any of the target appliances fail to meet the minimum criteria established by appliance attributes 126, for example, then application uploads from mobile device 102 are precluded due to the appliance attribute incompatibilities. As such, manual compatibility tests conventionally required are no longer necessary through operation of the present invention due to the automatic determination of appliance incompatibilities and application specific incompatibilities.

Proximity connection 104 may also be exemplified in terms of the Bluetooth standard for localized attribute discovery and subsequent data transfer. Bluetooth technology is an industry standard for short-range wireless voice and data communications, allowing a single air interface to support local communications for distances of up to 10-20 meters. Bluetooth operates in the 2.4 gigahertz (GHz) Industrial, Scientific, and Medical (ISM) band and uses a fast frequency hopping scheme with 79 frequency channels, each being 1 MHz wide. Bluetooth also incorporates a Service Discovery Protocol (SDP) as a middleware protocol of the Bluetooth stack. The SDP is used to locate and describe attributes associated with applications/data provided by or available through another Bluetooth device. The SDP performs this task by performing discovery of devices (e.g., appliance 106), their attributes (e.g., appliance attributes 126) and application/data attributes (e.g., 124) that are located within appliance 106.

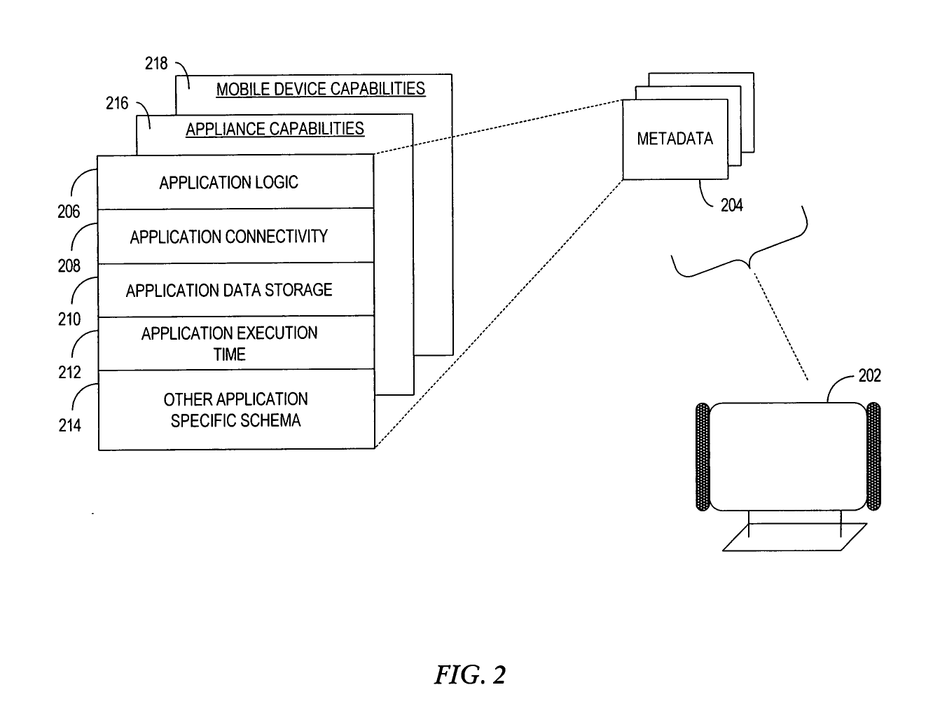

Several types of service schema may be used to define compatibility within the context of the present invention. In particular, three types of service schema are used: application specific service schema; appliance specific capability descriptions; and mobile device capability descriptions. FIG. 2, for example, illustrates the various types of service schema that may be described by metadata 204 that is internally stored within appliance 202. Service schema may exist for any service or application, regardless of whether the service/application exists within the appliance or the mobile device. Service schema are, in essence, a compilation of attributes and attribute values that are used by, for example, compatibility detection module 110 of FIG. 1, to insure that the correct attributes are shared by both the source and the target.

Application specific service schema, e.g., 206-214, are the first type of service schema, defined by metadata 204, that may be associated with applications 128 stored within a source appliance, e.g., appliance 202. For each application 128, a corresponding metadata entry 204 may exist to define the corresponding application attributes that are used by an interrogating mobile device to determine compatibility between the application and the mobile device, or to determine compatibility between the application and a target appliance.

Several types of application specific schema may exist, including application logic requirements 206 that may be required to define the particular configuration data that the application needs. For example, some applications require a data source, e.g., a database, during execution. Since the application itself is being ported into another device, the data source and/or its respective pathname must also be ported. As such, a configuration file, usually defined in extensible Markup Language (XML), should be used to define the location of the database. In other words, a <configuration> tag along with associated application settings, <appSettings>, may be inserted into an XML file of metadata 204 to set the database pathname in the target device. For example, the following code segment may be found within a typical XML file to set a database configuration attribute associated with any particular application 128:

<?xml version=“1.0”?>
<configuration>
<appSettings>

<add key=“DatabasePath” value=“mypathname” />
</appSettings>

</configuration>

Application specific connectivity requirements 208 may also be required to specify, for example, any communication protocols that may be required by applications 128. For example, appliance 202 may represent any number of home entertainment appliances such as TVs, home theatre receivers, and DVD players that utilize the IEEE 1394 standard for short distance, isochronous media transfer and control. IEEE 1394 also has the capability to transport Internet Protocol (IP), which enables UPnP technology over IP to extend into the home entertainment device network. Thus, since one of applications 128 may represent an IEEE 1394 based driver for home network uploads and downloads, IEEE 1394 may be one of the application specific connectivity requirements of applications 128 as specified by metadata file 208.

Application data storage requirements 210 may also be required to specify, for example, any data base engines or data schema that are to be used by applications 128. For example, the Hypersonic Software Query Language Database (HSQLDB) may be specified for use by metadata file 210, which is a relational database engine written in Java, with a Java Database Connectivity (JDBC) driver, supporting a rich subset of ANSI-92 SQL. It offers a lightweight, fast database engine that offers both in memory and disk based tables, which may be ported for operation into, for example, mobile device 102 of FIG. 1.

Application execution time requirements 212 may also be required to specify, for example, RAM resources, CPU speed, display characteristics, OS type, etc. as may be required by any of applications 128 at run time. For example, given that application 128 represents the IEEE 1394 based driver discussed above, then appropriate real time resources are required to accommodate the data to be transferred via IEEE 1394. That is to say, for example, that sufficient RAM is to be made available for an IEEE 1394 application 128 to store the large amounts of data required by the 400/800 Mbps transfer rate that is supported by IEEE 1394. Other application specific schema 214 may also be defined as required by the particular application 128 being interrogated for compatibility.

Appliance specific capability descriptions 216 and mobile device capability descriptions 218 may also be defined via metadata files 204 to further define compatibility in accordance with the present invention. Appliance specific capability descriptions 216, for example, may be extracted from appliance attributes 126 of FIG. 1 and converted into an XML file for transfer and subsequent interpretation by compatibility detection module 110. The appliance specific capability requirements may be related to the application specific requirements discussed above. For example, execution time requirements 212 may dictate a particular RAM depth that should be available within the target appliance prior to download of the application. Any RAM deficiency that may exist within the target appliance is then detected by compatibility detection module 110 through analysis of the execution time requirements 212 and then used to preclude download of application 128 to the target appliance due to the RAM deficiency.

Similar requirements may be defined within mobile device capability descriptions 218 to describe the compatibility of application 128 with mobile device 102. Since mobile devices are designed to be lightweight and portable, resources within the mobile device are generally scarce. Resources such as display size, RAM depth, and CPU speed, for example, may be identified within mobile device capability descriptions 218 to aid compatibility detection module 110 in the determination as to the compatibility of a particular application 128 with mobile device 102. It should be noted, that while a particular application 128 may be identified as being incompatible with mobile device 102, the application may nevertheless be uploaded to mobile device 102 for eventual download into a compatible target appliance.

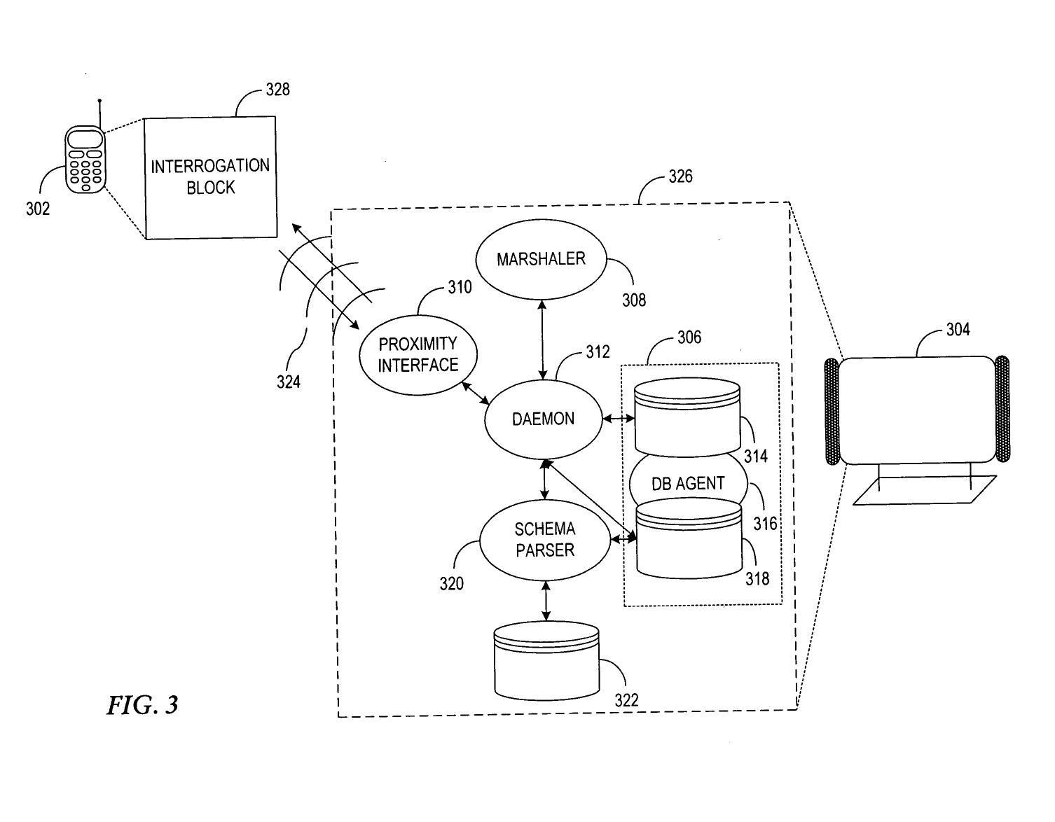

FIG. 3 exemplifies interrogation blocks 326 and 328 that may be utilized by the present invention to first detect a compatibility state and then initiate an upload/download session between mobile device 302 and appliance 304 once a minimally acceptable compatibility state has been determined. Mobile device 302 and appliance 304 are brought within a coverage area that is defined by proximity connection 324. A proximity interface (not shown) internal to interrogation block 328 of mobile device 302 establishes a peer-to-peer communication link with interrogation block 326 of appliance 304 through the use of, for example, NFC protocol. Once mobile device 302 and appliance 304 have “linked up”, a faster proximity interface, such as a Bluetooth interface, may be established after NFC configuration has taken place. Such may be the case, for example, when a high bandwidth, broadband connection is desired in order to exchange a large amount of data between mobile device 302 and appliance 304.

Using the NFC protocol, for example, mobile device 302 and appliance 304 share a single, half-duplex Radio Frequency (RF) band centered at 13.56 Mhz. The devices implement a listen-before-talk policy, such that prior to transmission, a device must first listen on the NFC carrier to verify that no other NFC devices are transmitting. Appliance 304 may be defined as the initiator, whereby an RF field is generated by proximity interface 310 and is detected by interrogation block 328 of mobile device 302. Once detected, data is transferred from appliance 304 to mobile device 302 in a passive mode of communication by load modulation, so that energy may be conserved within mobile device 302. Alternatively, mobile device 302 may also generate its own RF field in an active mode of communication, whereby data from mobile device 302 is actively transferred to appliance 304 using a separate half-duplex RF link.

The data transmitted by proximity interface 310 of interrogation link 326 is data that is generated for transmission by daemon 312 and marshaled by marshaler 308. In particular, appliance 304 utilizes daemon 312 as a broadcasting daemon, whereby application specific service schema, appliance specific capability descriptions, and mobile device capability descriptions, as discussed above in relation to FIG. 2, are marshaled and transmitted to mobile device 302 via proximity connection 324. Application specific service schema that is transmitted by transmission daemon 312 is first parsed from the applications resident within RAM 322 by schema parser 320 and supplied to database 318 of intra-appliance data store 306, generally in the form of XML based metadata files.

Appliance specific capability descriptions pertaining to appliance 304, as well as other appliance descriptions known to be compatible with appliance 304, are stored within database 314 of intra-appliance data store 306, generally also in the form of XML based metadata files. The metadata files are marshaled and transmitted to mobile device 302 once the peer-to-peer communication link is established. In addition to the application specific service schema and appliance specific capability descriptions transmitted by daemon 312 are the list of applications and data that are available within application RAM 322. Thus, a catalog of available information, data, and applications along with their respective compatibility attributes are provided by appliance 304 to mobile device 302 via proximity connection 324.

Similarly, mobile device 302 may transfer its catalog of available information, data, and/or applications, as well as the application specific service schema and appliance specific capability descriptions that are associated with the information, data, and/or applications, to appliance 304. In particular, the applications and associated schema may be downloaded from mobile device 302 to appliance 304 via interrogation block 328 through a transmission daemon (not shown) existent within interrogation block 328 of mobile device 302. In such a way, mobile device 302 and appliance 304 may simultaneously exchange lists of services, applications, and data that are not mutually possessed by each other. In so doing, mobile device 302 may create a deficiency list of services, applications, and data contained within appliance 304 that are not contained within mobile device 302. Likewise, appliance 304 may create a deficiency list of services, applications, and data contained within mobile device 302 that are not contained within appliance 304.

Once the deficiency lists have been created, either mobile device 302 and/or appliance 304 may begin a synchronization process, whereby an exchange of services, applications, and/or data may be effected in accordance with the associated capabilities and schema as defined by the XML based metadata files exchanged during the initialization process. Thus, the deficiency list may be thought of as a “shopping list” of components, data, or anything else from another node resident within the network, whether the node is fixed or wireless. In such an instance, data components or execution modules may be fetched from the data component or execution module provider from, for example, a WEB service provider for implementation of an auto update type of scheme. In one embodiment in accordance with the present invention, only those services, applications, and/or data that are identified as being compatible by database agent 316 and the corresponding database agent (not shown) internal to interrogation block 328 of mobile device 302 may be exchanged between mobile device 302 and appliance 304.

In an alternate embodiment in accordance with the present invention, the database agent (not shown) within interrogation block 328 may determine that services, applications, and/or data contained within appliance 304 are not compatible with mobile device 302. As such, the services, applications, and/or data are not deployable within the mobile device itself, but may nevertheless be uploaded to the mobile device for subsequent download to other appliances that are compatible with the services, applications, and data contained within appliance 304. Such services, applications, and data may be flagged as being incompatible with mobile device 302 and thus may exist within mobile device 302 only in their undeployed state space permitting.

In either instance, the services, applications, and/or data that are uploaded to mobile device 302 are included within the service catalog of the mobile device. The updated service catalog is then advertised to subsequent target appliances that may be compatible with the advertised services, applications, and/or data. As such, a subsequent download of the services, applications, and/or data from the mobile device to the target appliance may be effected as desired.

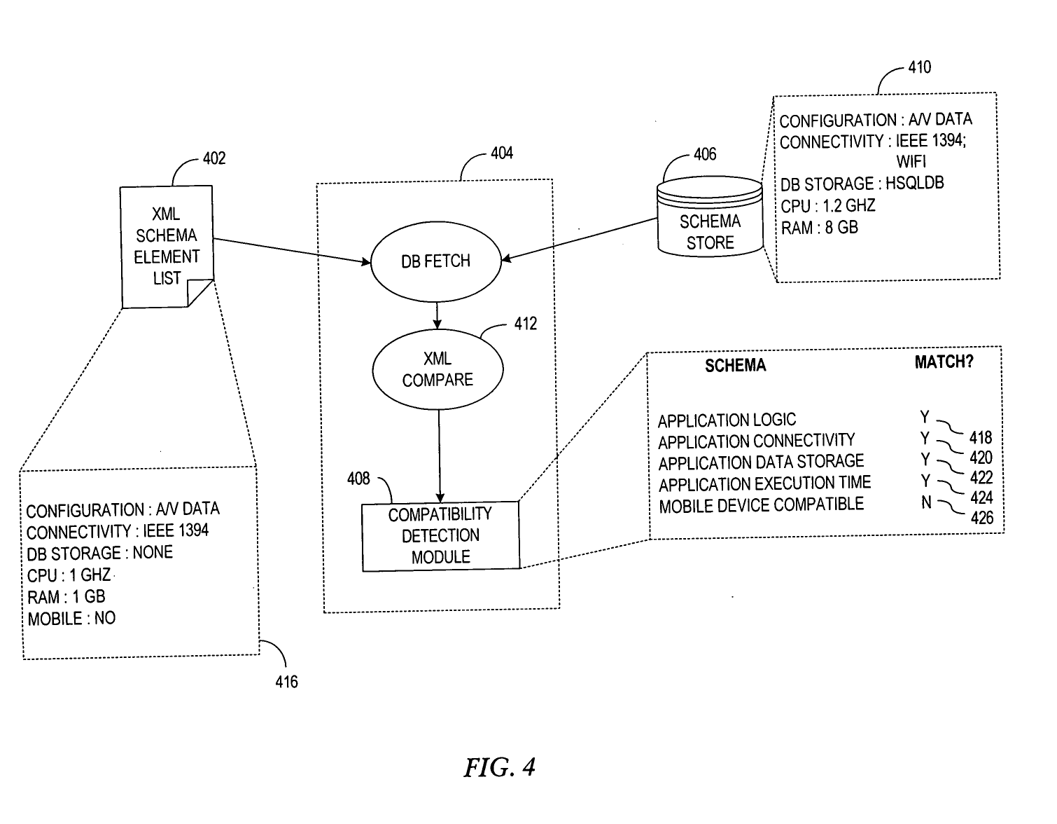

Turning to FIG. 4, an exemplary block diagram of database agent 404 in accordance with the present invention is illustrated. In particular, database agent 404 exists within either of interrogation blocks 326 and 328 of FIG. 3 and is responsible for the determination of the existence of a compatibility match between the services, applications, and/or data that have been located within either device. In general, database agent 404 filters schema associated with newly discovered services, applications, and data by comparing the schema to local schema store 406. Various levels of compatibility may emerge from such a comparison, where each level of compatibility is effective to dictate whether the upload/download of the services, applications, and/or data is to take place. If an upload/download is to take place, then the comparison is further effective to determine whether the newly acquired services, applications, and/or data are deployable within the acquiring host, or whether the acquiring host is meant only to be a porting device for other target appliances.

XML schema element 402 may represent an XML based metadata file resulting from a proximity based, initialization data exchange as discussed above in relation to FIG. 3. In particular, the interrogated appliance may utilize a broadcasting daemon to transmit application specific service schema, appliance specific capability descriptions, and mobile device capability descriptions to an interrogating device via a previously established peer-to-peer connection. The interrogating device may then compare the entries of XML schema element 402 to internally stored XML documents 406 containing a predetermined set of schema, to determine whether compatibility exists between the services, applications, and/or data represented by XML schema element 402 and internally stored XML documents 406.

In an exemplary embodiment, the interrogating device may be represented, for example, by mobile device 302 of FIG. 3. Accordingly, the interrogated device may be represented by appliance 304. The comparisons performed by XML compare block 412 are thus performed by mobile device 302 and are executed for each XML entry 416 contained within XML schema element 402. XML comparison 412 may yield a number of results, which depending upon the value of the XML entry, may or may not result in a determination of affirmative compatibility. For example, the first entry contained within XML schema element 416 indicates that the corresponding application contained within appliance 304 requires data storage for Audio/Video (A/V) data. Since comparison schema 410 indicates A/V data support, the resulting compatibility result 418 for the application logic schema is affirmative, i.e., “Y”.

It should be noted that comparison schema 410 may represent any variation of predetermined schema that may be applicable for the particular application or target appliance. For example, a home network may be implemented using a wide variety of home appliances having a varied set of attributes. The varied set of attributes may then be incorporated into comparison schema 410 and utilized by an interrogating device, e.g., mobile device 302, to make compatibility determinations in accordance with the present invention. Thus in this example, other appliances exist in the home network that support A/V data and as such, could benefit from the A/V data supported application existent within appliance 304.

Similarly, the second entry contained within XML schema element 416 indicates that the corresponding application contained within appliance 304 requires IEEE 1394 capability. Since comparison schema 410 indicates either IEEE 1394 or WiFi connectivity is supported by the home network, the resulting compatibility result 420 for the application connectivity schema is also affirmative. The third, fourth, and fifth entries contained within XML schema element 416 indicate that the corresponding application contained within appliance 304 requires no database support, at least a CPU operational speed of 1 GHz, and at least 1 GB of RAM, respectively. Since comparison schema 410 indicates HSQLDB database engine support, 1.2 GHz CPU support, and 8 GB RAM availability within the home network, compatibility results 422-424 for the application data storage and execution time schema, respectively, are also affirmative.

The last entry contained within XML schema element 416 indicates that the corresponding application contained within appliance 304 cannot be deployed within a mobile device. Thus, mobile compatibility indication 426 is reported to be negative, i.e., “N”. Based on affirmative compatibility results 418-424, an affirmative upload determination is likely to be made by database agent 404, which results in the transfer of the compatible application contained within appliance 304 to mobile device 302 via proximity connection 324.

It should be noted that even though mobile compatibility indication 426 is negative, the upload from appliance 304 into mobile device 302 is nevertheless possible. In such an instance, mobile device 302 uploads the application and temporarily stores it until a compatible appliance, or software component, is located for download. In particular, once the interrogation session between mobile device 302 and appliance 304 has completed, mobile device 302 may roam into the coverage area of a prospective target appliance within the network to commence a download of the newly acquired application into the target appliance after an affirmative compatibility determination has been made between the newly acquired application and the prospective target appliance.

It can be seen, therefore, that database agent 404 makes compatibility determinations based upon varying degrees of compatibility. For example, an exact match between the A/V data application configuration requirement indicated in XML schema element 416 and comparison schema 410 resulted in an affirmative compatibility match. Alternatively, a partial match led to an affirmative compatibility result when the application connectivity requirement of IEEE 1394 of XML schema element 416 was compared to the supported connectivity range of either IEEE 1394 or WiFi of comparison schema 410. Two matches were found within an approved value limit when the required CPU speed of 1 GHz and the required RAM depth of 1 GB of XML schema element 416 was compared to the supported CPU speed range of 1.2 GHz and the supported RAM depth range of 8 GB of comparison schema 410, respectively. Other comparisons, such as a pattern match between XML schema element 416 and comparison schema 410, may yield similar compatibility results.

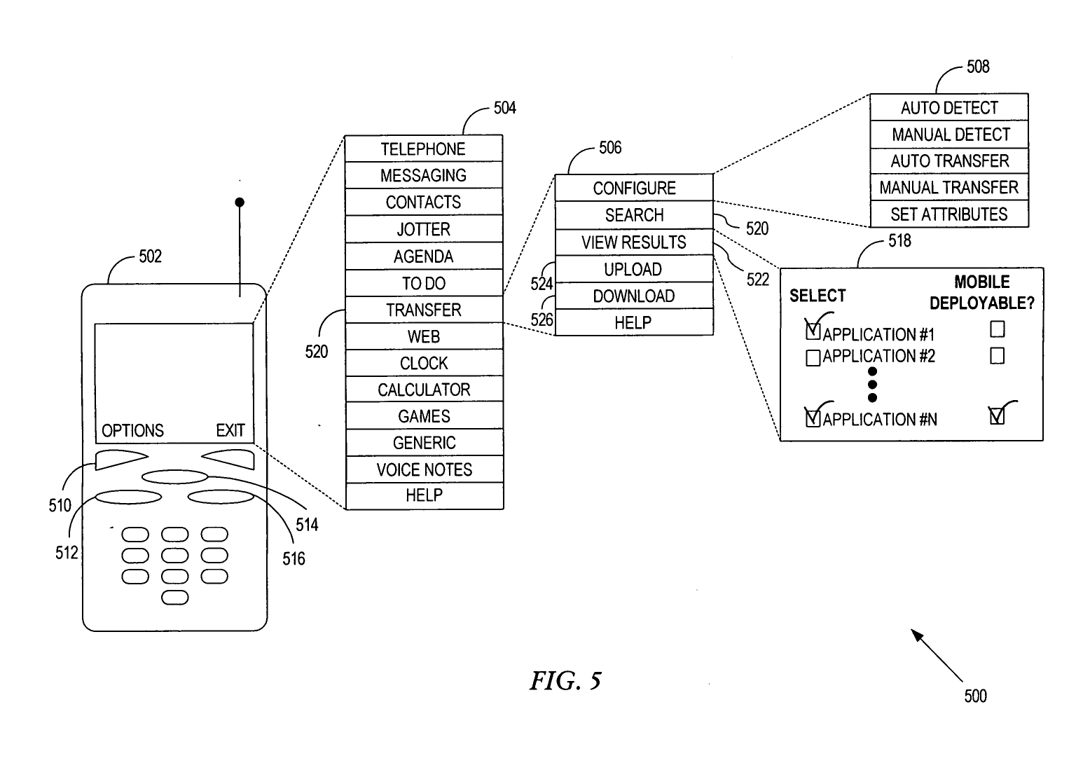

While the present invention allows for the automatic exchange of information, data, and/or applications based on automatic compatibility determinations, the present invention also contemplates a User Interface (UI) implementation that allows a user of the mobile device to initiate and intercede at any point during the discovery process. In particular, the user of mobile terminal 502 illustrated in FIG. 5 may navigate through menu 504 to instantiate transfer selection 520 in accordance with the present invention. In particular, by pressing options key 510 once, sub-menu 504 allows the user of mobile terminal 502 to configure proximity transfer characteristics through instantiation of configure option 506. By pressing either of up key 512 or down key 516, one of the other options of sub-menu 504 may be highlighted and ultimately selected by pressing select key 514.

For example, the user of mobile device 502, having selected configure sub-option 506, may then proceed to configure the operational aspects of application detection and exchange through configuration selections 508. Automatic detection may be selected, for example, whereby once mobile device 502 comes into the coverage area of a proximately located appliance, applications and associated schema may be automatically detected and displayed to the user of mobile terminal 502 resulting in display 518. Alternately, the user may select manual detection, whereby only after selection of SEARCH option 520 are applications and their associated schema uploaded into mobile device 502 for subsequent viewing after selection of VIEW RESULTS option 522. In other embodiments, the automatic and/or manual detection of applications and associated schema may be protected through a combination of software, encryption technologies, and services, such as implemented by the Public Key Infrastructure (PKI).

Applications #1 through #N of display 518, for example, may represent all of the cataloged applications that exist within an interrogated appliance that also comply with the required application attributes as selected by the user through the SET ATTRIBUTES selection of configure sub-option 506. Each application that is itemized within display 518 may also provide an indication as to whether the application is deployable within mobile device 502. Manual selection of the itemized applications of display 518 may be facilitated, such that after selection of UPLOAD sub-option 524, they may be uploaded from the appliance into a temporary storage area (not shown) within mobile device 502 for subsequent transfer to a target appliance. Alternately, if the application is deployable within mobile device 502, the application may be uploaded into the operational environment of mobile terminal 502 for subsequent deployment within mobile terminal 502.

Applications #1 through #N may alternately represent those applications resident within mobile device 502 that are deployable to a target appliance. In such an instance, selection of the applications itemized within display 518 and subsequent selection of DOWNLOAD option 526 results in the download of the selected applications into the proximately located target appliance.

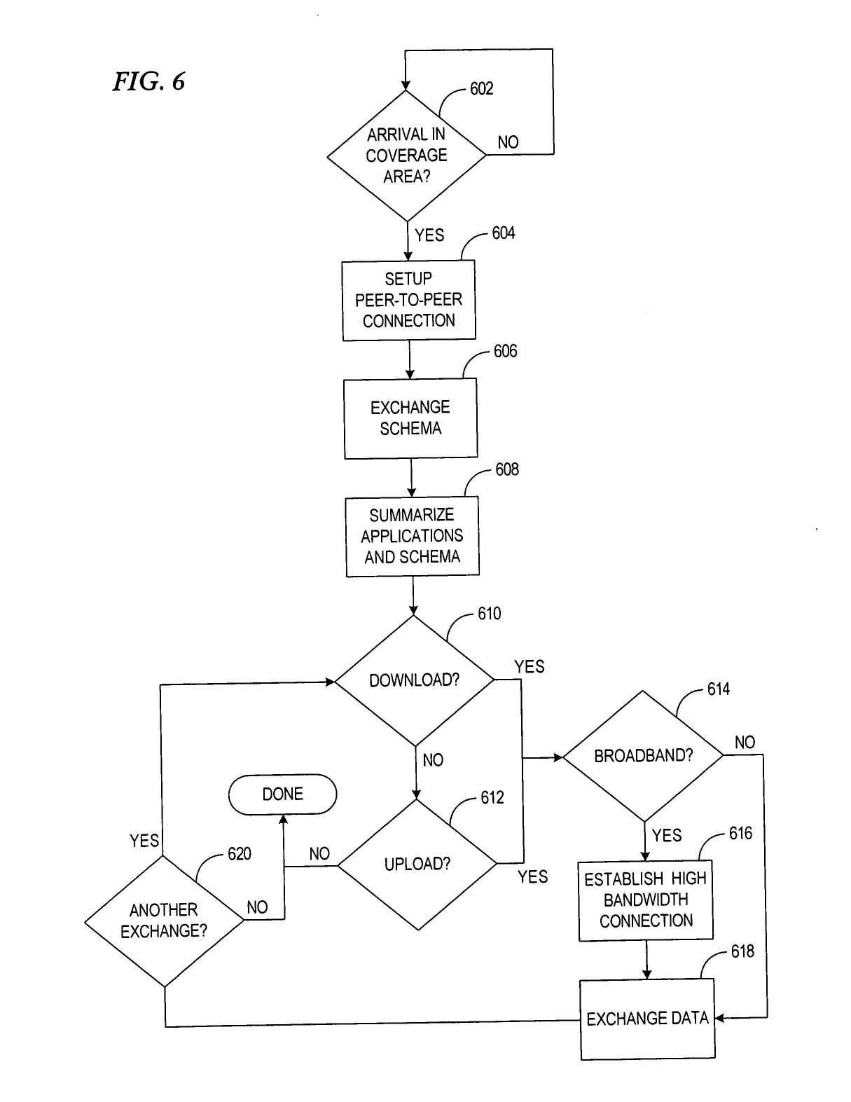

Turning to the flow diagram of FIG. 6, an exemplary method in accordance with the present invention is illustrated. Placement of the mobile device within a coverage area of an associated appliance is detected as in step 602. Once a proximity connection is possible, a peer-to-peer connection is established as in step 604 in accordance with any number of proximity based communication protocols, such as NFC or Bluetooth, as discussed above. In accordance with configuration selections 508 as discussed above in relation to FIG. 5, the exchange of applications and their related schema may be facilitated either manually or automatically as in step 606. The subsequent summary of the applications and related schema may then be presented to the user of the mobile device as in step 608.

It should be noted, that the summary of applications and associated schema as presented in step 608 may either be those applications that are either resident within an interrogated appliance and available for upload to the mobile device, or conversely the summary of applications and associated schema may be those applications that are resident within the mobile device that are available for download to the target appliance. If the applications are available for download from a mobile device to a target appliance as determined in step 610, then a determination is made in step 614 as to whether a higher bandwidth protocol, such as Bluetooth, is required for data transfer.

If a higher bandwidth protocol is to be utilized, then the peer-to-peer connection between the mobile device and the appliance may be upgraded as in step 616 for subsequent data transfer as in step 618. If, on the other hand, applications are available for upload from the appliance to the mobile device as determined in step 612, then a determination is made in step 614 as to whether a higher bandwidth protocol, such as Bluetooth, is required for data transfer. If a higher bandwidth protocol is to be utilized, then the peer-to-peer connection between the mobile device and the appliance may be upgraded as in step 616 for subsequent data transfer as in step 618. Similarly, other exchanges that may be necessary are determined in step 620 and similarly executed.

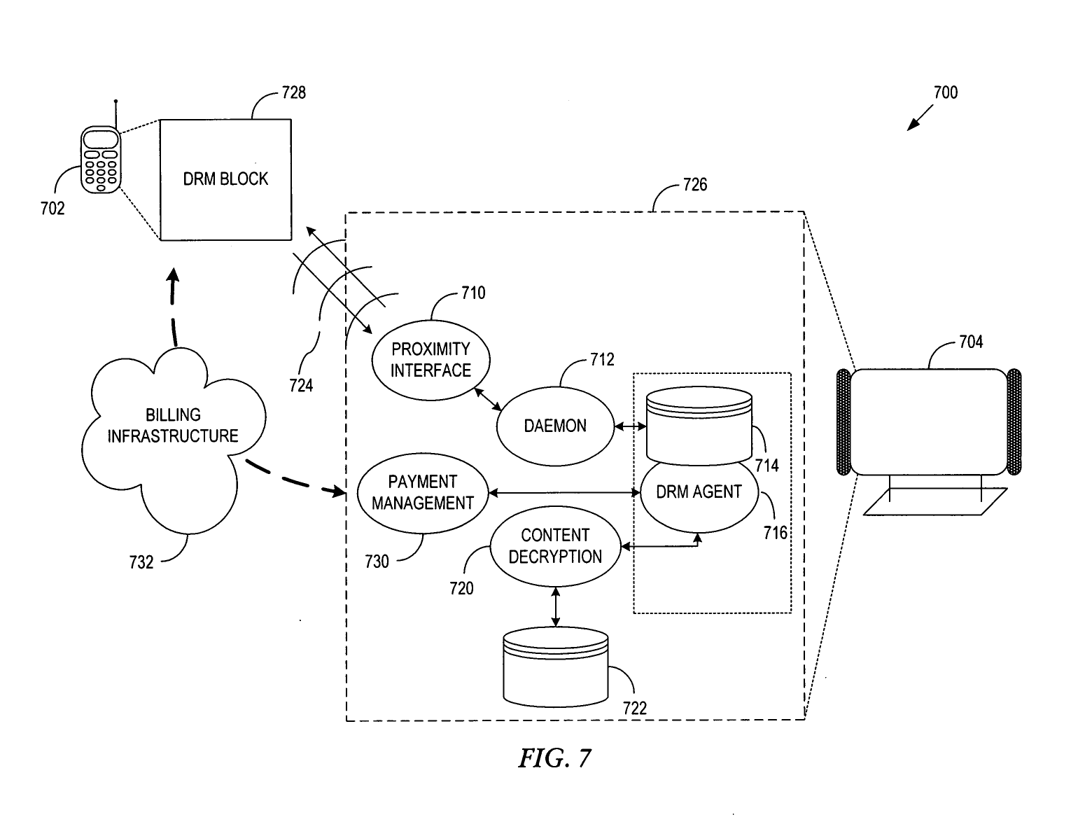

In an alternate embodiment in accordance with the present invention, a Digital Rights Management (DRM) implementation is contemplated, whereby in addition to content compatibility, digital rights to the content is also analyzed so that the content owner's rights against illegal copying and other use may be substantially eliminated. Enforcement of the content owner's rights is generally performed through the encryption of the content and related rights to the content prior to delivery. FIG. 7 illustrates an exemplary DRM system, which enables content discovery and delivery methods that yield superdistribution of the content while also protecting the rights of the content owners in accordance with the present invention.

DRM discovery/delivery system 700 of FIG. 7 achieves protection of distributed content through encryption of the content and related rights to the content prior to dissemination. Content contained within either of mobile device 702 or appliance 704 may consist of music, images, movies, e-books, ringing tones, games, multimedia applications, Java applets, etc., that have been created and packaged using encryption, e.g., symmetric key technology, such as the Advanced Encryption Standard (AES). Once encrypted, the content is free for distribution, since only the Content Encryption Key (CEK) that is used to encrypt the content is to be protected.

Encrypted content contained within content store 722 of appliance 704 is generally associated with a voucher. A voucher is an entity which contains the CEK associated with the encrypted content, related usage rights to the encrypted content, and a reference to the encrypted content package contained within content store 722. The related usage rights to the content may include frequency of usage, e.g., use once or use many times. Related usage rights to the content may also include the mode in which the acquirer wishes to use the content, e.g., using playback, copy, or modification privileges.

Usage rights may be expressed with XML based Rights Expression Languages (REL) through operation of DRM agent 716 and stored within voucher store 714. Such vouchers may also include metadata 204 as exemplified in FIG. 2 to describe the related application, appliance, and mobile device capabilities associated with the content. The vouchers may then be advertised by transmission daemon 712 and proximity interface 710 via proximity interface 724 to any mobile device 702 having entered the coverage area defined by proximity interface 724. Such advertisements may include a list of the available content within content store 722 that is available for consumption by mobile device 702.

The vouchers themselves may be encrypted using, e.g., symmetric encryption, while the list of available content within content store 722 and associated schema is left unencrypted. Thus, mobile device 702 may first analyze the available content within appliance 704 and associated schema prior to making a decision to upload. An invitation to receive the encrypted voucher may then be extended to mobile device 702 from DRM agent 716 of appliance 704. The invitation may either be accepted or declined by the response of DRM block 728 of mobile device 702 to the invitation. If the invitation is accepted by mobile device 702, then DRM agent 716 may optionally verify acceptance of the charges associated with the voucher by mobile device 702.

In such an instance, DRM block 728 accepts the charges for the voucher by contacting billing infrastructure 732 and forwarding payment for the voucher to billing infrastructure 732. Payment management block 730 then forwards the affirmation received from billing infrastructure 732 to DRM agent 716, which is then effective to cause the upload of the voucher (including the CEK) to mobile device 702. Since the upload is effected using, for example, NFC protocol, the upload itself is considered to be secure.

The invention is a modular invention, whereby processing functions within either a mobile device or an appliance may be utilized to implement the present invention. The mobile devices may be any type of wireless device, such as wireless/cellular telephones, personal digital assistants (PDAs), or other wireless handsets, as well as portable computing devices capable of wireless communication. The appliances may include PC category devices that allow each user to interact with each other via the Internet. Still other appliances include those in the broadcast category that serves set-top boxes and other traditional consumer electronics, such as satellite television (TV) receivers, broadcast tuners, video and imaging capture devices, etc. These appliances utilize computing circuitry and software to control and manage the conventional device activity as well as the functionality provided by the present invention. Hardware, firmware, software or a combination thereof may be used to perform the various data exchange functions described herein.

The exemplary mobile computing arrangement 800 suitable for transferring data in accordance with the present invention may be associated with a number of different types of wireless devices. The representative mobile computing arrangement 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal, and also those functions associated with the present invention as dictated by UI module 826, DRM module 828, application storage 830, proximity interface 832, and interrogation module 834 available in the program storage/memory 804. Thus, the processing unit 802 is capable of initiating interrogation functions associated with the present invention, whereby applications and associated schema contained within other appliances may be identified. Once identified, the applications may be uploaded into application storage 830 and either deployed within the mobile device and/or temporarily stored for subsequent download into other target appliances. The program storage/memory 804 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 804 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 800 via data signals, such as being downloaded electronically via one or more networks, such as the Internet and an intermediate wireless network(s).

The processor 802 is also coupled to user-interface 806 elements associated with the mobile terminal. The user-interface 806 of the mobile terminal may include, for example, a display 808 such as a liquid crystal display, a keypad 810, speaker 812, and microphone 814. These and other user-interface components are coupled to the processor 802 as is known in the art. Other user-interface mechanisms may be employed, such as voice commands, switches, touch pad/screen, graphical user interface using a pointing device, trackball, joystick, or any other user interface mechanism.

The mobile computing arrangement 800 also includes conventional circuitry for performing wireless transmissions. A digital signal processor (DSP) 816 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits the outgoing radio signals 822 and receives the incoming radio signals 824 associated with the wireless device.

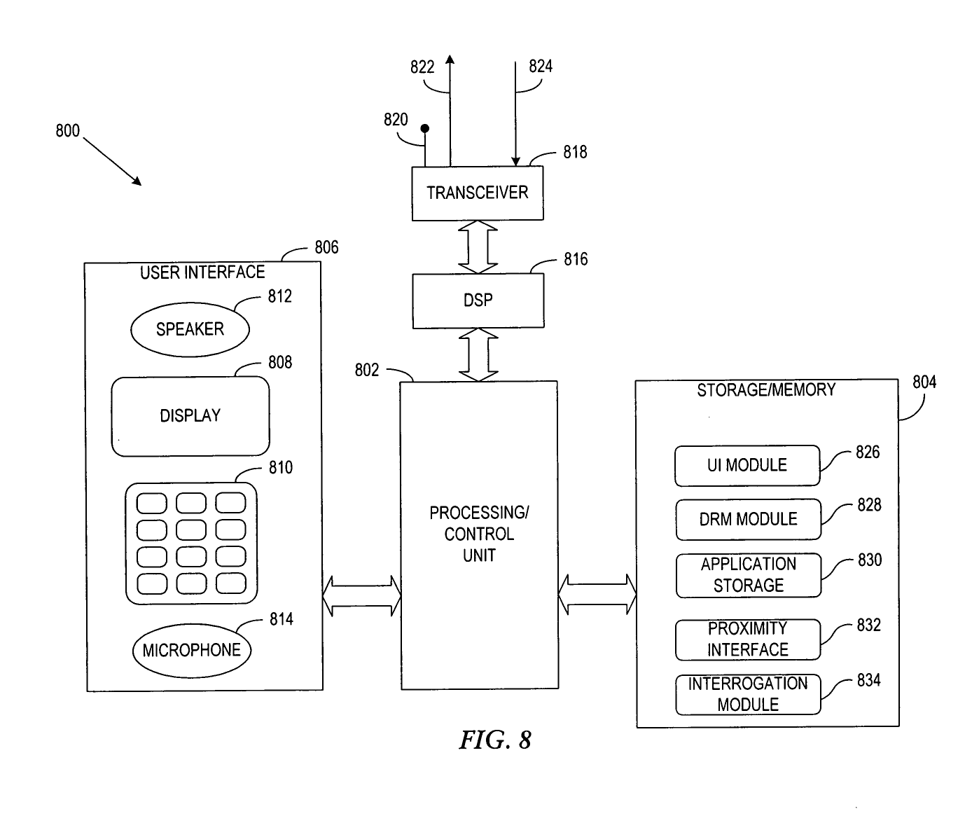

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a data transfer system and method in accordance with the present invention.

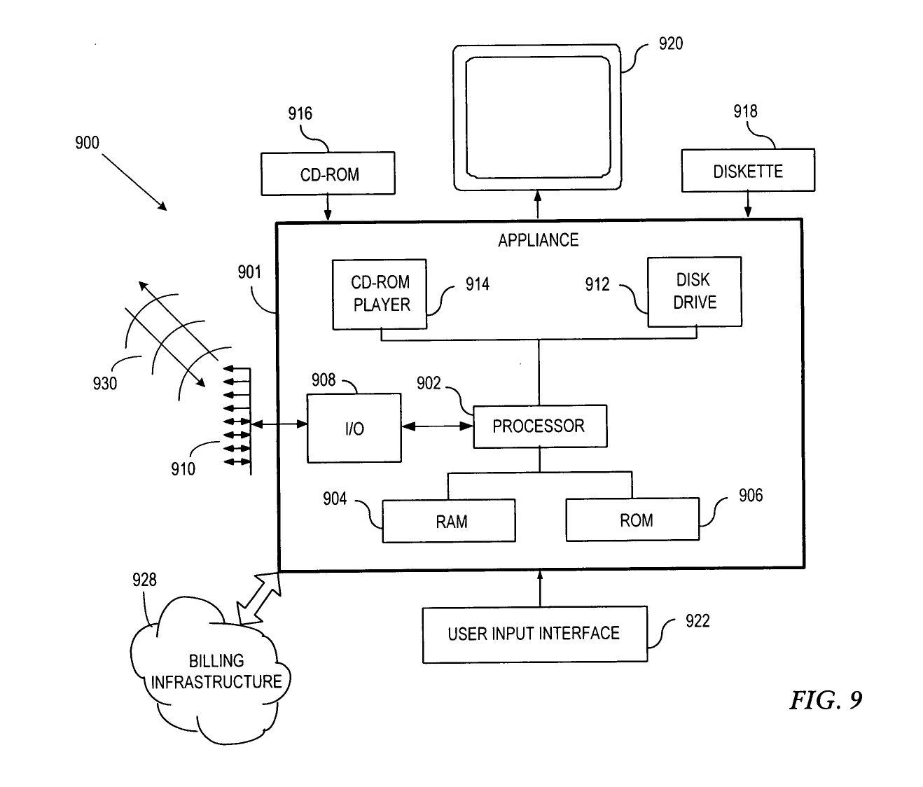

The appliances for providing applications and data in connection with the present invention may be any type of computing device capable of processing and communicating digital information. The appliances utilize computing systems to automatically deploy the applications received from the transporting mobile terminals. An example of a representative computing system capable of carrying out operations in accordance with the invention is illustrated in FIG. 9. Hardware, firmware, software or a combination thereof may be used to perform the various appliance functions and operations described herein. The computing structure 900 of FIG. 9 is an example computing structure that can be used in connection with such an appliance.

The example computing arrangement 900 suitable for performing activity in accordance with the present invention includes appliance 901, which includes a central processor (CPU) 902 coupled to random access memory (RAM) 904 and read-only memory (ROM) 906. The ROM 906 may also be other types of storage media to store programs, such as programmable ROM (PROM), erasable PROM (EPROM), etc. Thus, RAM 904 and ROM 906 may combine to form a catalog application for providing a list of available application packages and a summary of execution requirements for those application packages that are available for upload/download into/from a requesting mobile device.

The processor 902 may communicate with other internal and external components through input/output (I/O) circuitry 908 and bussing 910, to provide control signals and the like. For example, data received from proximity I/O connections 930 may be processed using NFC protocol, or the like, to facilitate the upload and download of applications in accordance with the present invention. External networks, such as billing infrastructure 928, may be coupled to appliance 901 to facilitate DRM functions according to the present invention. The processor 902 carries out a variety of functions as is known in the art, as dictated by software and/or firmware instructions.

Appliance 901 may also include one or more data storage devices, including hard and floppy disk drives 912, CD-ROM drives 914, and other hardware capable of reading and/or storing information such as DVD, etc. In one embodiment, software for carrying out the data exchange operations in accordance with the present invention may be stored and distributed on a CD-ROM 916, diskette 918 or other form of media capable of portably storing information. These storage media may be inserted into, and read by, devices such as the CD-ROM drive 914, the disk drive 912, etc. The software may also be transmitted to appliance 901 via data signals, such as being downloaded electronically via a network, such as the Internet. Appliance 901 may be coupled to a display 920, which may be any type of known display or presentation screen, such as LCD displays, plasma display, cathode ray tubes (CRT), etc. A user input interface 922 may also be provided, including one or more user interface mechanisms such as a mouse, keyboard, microphone, touch pad, touch screen, voice-recognition system, etc.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A method of transferring applications between a computing source and a computing target, the method comprising:
establishing a connection between the computing source and an interrogation device;
transmitting schema associated with the applications from the computing source to the interrogation device;
comparing the schema to compatibility criteria to generate a compatibility result; and
transmitting the applications from the computing source to the interrogation device in response to the compatibility result.

2. The method of claim 1, wherein the connection is automatically established once the interrogation device enters a wireless coverage area associated with the computing source.

3. The method of claim 2, wherein a first level of operational performance of the connection is initially established and a second level, upgraded from the first level of operational performance of the connection, is generated in response to a size of the application to be transmitted.

4. The method of claim 1, wherein the schema includes extensible Markup Language (XML) based metadata files.

5. The method of claim 1, further comprising transmitting schema associated with capability requirements of the interrogation device from the computing source to the interrogation device.

6. The method of claim 5, further comprising transmitting schema associated with capability requirements of the computing target from the computing source to the interrogation device.

7. The method of claim 1, wherein comparing the schema results in an affirmative compatibility result based upon an exact match between the schema and the compatibility criteria.

8. The method of claim 1, wherein comparing the schema results in an affirmative compatibility result based upon an approved value limit between the schema and the compatibility criteria.

9. The method of claim 1, wherein comparing the schema results in an affirmative compatibility result based upon a partial match between the schema and the compatibility criteria.

10. The method of claim 1, further comprising updating a service catalog of the interrogating device to reflect the applications received from the computing source.

11. The method of claim 10, further comprising advertising the updated service catalog to the computing target once the interrogation device enters a wireless coverage area associated with the computing target.

12. The method of claim 11, further comprising downloading the received applications from the interrogation device to the computing target that are deemed to be compatible with the computing target.

13. The method of claim 1, wherein the compatibility result is further based upon rights established for the interrogation device by a Digital Rights Management (DRM) agent.

14. The method of claim 13, wherein affirmative DRM rights are established for the interrogation device upon verification of the acceptance of charges associated with the transmitted applications by the interrogation device.

15. A system for enabling application transfer between a source appliance and a target appliance, the system comprising:
a source appliance containing a list of applications and associated attributes to be transmitted in response to creation of a proximity connection;
an interrogation device capable of wirelessly coupling to the source appliance via the proximity connection and adapted to compare the associated attributes to a set of compatibility criteria to generate a first compatibility result, wherein the interrogation device uploads the applications via the proximity connection in response to the first compatibility result; and
a target appliance capable of wirelessly coupling to the interrogation device and adapted to receive the uploaded applications from the interrogation device in response to the generation of a second compatibility result.

16. The system of claim 15, wherein the source appliance comprises a parser adapted to generate the associated attributes from the applications stored within the source appliance.

17. The system of claim 16, wherein the source appliance further comprises an execution environment adapted to execute the applications stored within the source appliance.

18. The system of claim 17, wherein the source appliance further comprises a payment management module coupled to a billing infrastructure and adapted to approve the application upload in response to an acceptance by the interrogation device of charges generated by the billing infrastructure for the application upload.

19. The system of claim 15, wherein the interrogation device comprises a database agent adapted to fetch the set of compatibility criteria from the attributes transmitted from the source appliance.

20. The system of claim 19, wherein the database agent comprises a comparison module adapted to perform an eXtensible Markup Language (XML) based comparison of the associated attributes with the set of compatibility criteria.

21. The system of claim 20, wherein the database agent further comprises a compatibility detection module coupled to the comparison module and adapted to generate the first compatibility result based upon the XML based comparison.

22. An application source appliance comprising:
means for establishing a proximate connection to an external device;
means for providing attributes associated with applications stored within the application source appliance to the external device via the proximate connection;
means for executing the applications within the application source appliance; and
means for transferring the applications to the external device via the proximate connection in response to a capability match between the attributes associated with the applications and compatibility criteria contained within the external device.

23. A computer-readable medium having instructions stored thereon which are executable by a source appliance by performing steps comprising:
establishing a proximate connection to an external device;
providing attributes associated with applications stored within the source appliance to the external device via the proximate connection;
executing the applications within the source appliance; and
transferring the applications to the external device via the proximate connection in response to a capability match between the attributes associated with the applications and compatibility criteria contained within the external device.

24. The computer-readable medium of claim 23, wherein the instructions further perform steps comprising authorizing the transfer of applications to the external device in response to receiving verification that the external device accepted charges associated with the transfer of applications.

25. A mobile terminal capable of wirelessly coupling to a data transfer system, the mobile terminal comprising:
a memory capable of storing at least one of a proximity interface module and an interrogation module; and
a processor coupled to the memory and configured by the proximity interface module to enable transfer of a list of applications contained within a source appliance and attributes associated with the list of applications, wherein the processor is further configured by the interrogation module to compare the attributes to capability criteria, and in response, to generate a list of compatible applications available from the source appliance that match the capability criteria.

26. The mobile terminal of claim 25, wherein the memory is further capable of storing a User Interface (UI) module.

27. The mobile terminal of claim 26, wherein the processor is further configured by the UI module to display the list of compatible applications.

28. The mobile terminal of claim 27, wherein the processor is further configured by the UI module to allow a user of the mobile terminal to select one or more applications from the list of compatible applications for upload.

29. The mobile terminal of claim 28, wherein the processor is further configured by the UI module to indicate which of the list of compatible applications may be deployed within the mobile terminal.

30. The mobile terminal of claim 29, wherein the memory is further capable of storing the one or more applications selected for upload.

31. The mobile terminal of claim 30, further comprising an execution environment capable of executing those applications that are deployable within the mobile terminal.

32. The mobile terminal of claim 28, wherein the memory is further capable of storing a Digital Rights Management (DRM) module.

33. The mobile terminal of claim 32, wherein the processor is further configured by the DRM module to contact a billing infrastructure of the data transfer system to accept charges associated with the upload of applications from the source appliance.

34. A computer-readable medium having instructions stored thereon which are executable by a mobile terminal for effecting data transfer between a source appliance and a target appliance by performing steps comprising:
wirelessly obtaining a list of applications and associated attributes contained within the source appliance;
comparing the associated attributes to a set of capability criteria to generate a compatibility result for each application; and
generating a list containing each application from the source appliance that has an affirmative compatibility result.

35. The computer-readable medium of claim 34, wherein the instructions further perform steps comprising displaying the list of compatible source appliance applications.

36. The computer-readable medium of claim 35, wherein the instructions further perform steps comprising allowing User Interface (UI) selection for upload of one or more compatible source appliance applications from the list.
